(19) United States
(12) Patent Application Publication
(10) Pub. No.: US 2023/0009318 A1
(43) Pub. Date: Jan. 12, 2023

(54) Measuring Method and Measuring Assembly

(71) Applicant: VEGA GRIESHABER KG, Wolfach (DE)

(72) Inventors: Andreas Isenmann, Haslach i.K. (DE); Clemens Hengstler, Haslach (DE); Florian Burgert, Gengenbach (DE)

(21) Appl. No.: 17/834,045

(22) Filed: Jun. 7, 2022

(30) Foreign Application Priority Data
Jul. 9, 2021 (EP) 21184907.0

(51) Int. Cl. G01N 9/00; G01F 23/14

(52) U.S. Cl. CPC G01N 9/00; G01F 23/14

(57) ABSTRACT

A method for determining a measurement result, comprising the steps of: measuring a measuring quantity by means of a first measuring device at a measuring point, wherein the first device detects a first measurement value, measuring a reference measuring quantity by means of a second measuring device and an assembly for determining a result is proposed, which comprises: a first measuring device for measuring a measuring quantity at a measuring point, wherein the first device is configured for detecting a first value during the measurement of the measuring quantity and for determining the result using the first value and a second value, and a second measuring device for measuring a reference measuring quantity, wherein the second device is configured for detecting the second value during the measurement of the reference measuring quantity and causing a data transmission of the second value from the second device to the first device.

### CROSS REFERENCE TO RELATED APPLICATIONS

This patent application claims priority to European Patent Application 21184907.0, filed on Jul. 9, 2021.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a measuring method for determining a measurement result and a measuring assembly for determining a measurement result.

### Background of the Invention

In industrial metrology, particularly in the sector of process automation and process control, measuring devices, such as field devices, are regularly used for acquiring one or more process variables or process measuring quantities. In particular, field devices include flow, flow rate, pressure, pressure differential, temperature and filling level measuring devices. Using a corresponding measuring device or a corresponding measuring assembly, the field devices generally acquire a measurement signal that correlates with one or more measuring quantities. In order to determine certain measurement results, it may be necessary to acquire measurement values by means of several measuring devices, e.g. for determining a pressure differential. The values measured by the measuring devices are processed by a central unit, e.g. by a PLC computer or other control unit, which has to be specially configured or programmed for evaluating the values measured by the measuring devices.

In contrast thereto, the invention is based on the object of providing a measuring method and a measuring assembly in which a corresponding arrangement of a central unit is not necessary. The object is achieved by specifying the measuring method and the measuring assembly as described herein. This includes the various mutually independent advantageous developments of the present invention, also as described herein, whose features can be freely combined with each other by the person skilled in the art within the context of what is technically feasible.

### BRIEF SUMMARY OF THE INVENTION

In a preferred embodiment, a measuring method for determining a measurement result, comprising the steps of:
measuring a measuring quantity by means of a first measuring device (3) at a measuring point, wherein the first measuring device (3) detects a first measurement value,
measuring a reference measuring quantity by means of a second measuring device (6), wherein the second measuring device (6) detects a second measurement value,
data transmission of the second measurement value from the second measuring device (6) to the first measuring device (3), and
determination of the measurement result by the first measuring device (3) using the first measurement value and the second measurement value.

In another preferred embodiment, the measuring method as described herein, characterized in that the measuring quantity is an absolute pressure in a container (2), such as a tank, a pipe or the like, the reference measuring quantity is an atmospheric pressure, and the measurement result is a relative pressure.

In another preferred embodiment, the measuring method as described herein, characterized in that the first measuring device (3) calculates a difference between the first measurement value and the second measurement value for determining the measurement result.

In another preferred embodiment, the measuring method as described herein, characterized in that the first measuring device (3) displays the relative pressure on a display means of the first measuring device (3).

In another preferred embodiment, the measuring method as described herein, characterized in that the first measuring device (3) derives a filling level in the container (2) from the measurement result.

In another preferred embodiment, the measuring method as described herein, characterized in that the measuring quantity is a first pressure in a container (2), such as a tank, a pipe or the like, that the reference measuring quantity is a second pressure, and that the measurement result is a pressure differential.

In another preferred embodiment, the measuring method as described herein, characterized in that the measuring quantity and the reference measuring quantity are different physical quantities.

In another preferred embodiment, the measuring method as described herein, characterized in that the measuring quantity is a pressure in a container (2), such as a tank, a pipe or the like, that the reference measuring quantity is a distance between the second measuring device (6) and a filling level of a filling material in the container (2), and that the measurement result is a density of the filling material, wherein the first measuring device (3) has a pressure sensor and the second measuring device (6) has a distance sensor.

In another preferred embodiment, the measuring method as described herein, characterized in that the second measuring device (6) is disposed remote from the measuring point.

In another preferred embodiment, the measuring method as described herein, characterized in that at least one additional measuring device (7) measures the reference measuring quantity, wherein the at least one additional measuring device (7) detects an additional measurement value, wherein a data transmission of the additional measurement value from the additional measuring device (7) to the first measuring device (3) takes place, and wherein the first measuring device (3) compares the second measurement value with the additional measurement value prior to the determination of the measurement result in order to discard and/or correct the second measurement value.

In another preferred embodiment, the measuring method as described herein, characterized in that at least one additional measuring device (7) measures the reference measuring quantity, wherein the at least one additional measuring device (7) detects an additional measurement value, wherein a data transmission of the additional measurement value from the additional measuring device (7) to the second measuring device (6) takes place, and wherein the second measuring device (6) compares the second measurement value with the additional measurement value and outputs an error signal if a difference between the second measurement value and the additional measurement value exceeds a threshold value.

In another preferred embodiment, the measuring method as described herein, characterized in that the first measuring device (3), in addition to the measuring quantity, measures the reference measuring quantity, wherein the first measuring device (3) detects a third measurement value, and wherein a data transmission of the third measurement value from the first measuring device (3) to at least one third measuring device takes place.

In another preferred embodiment, the measuring method as described herein, characterized in that the first measuring device (3) sends a request, whereupon the second measuring device (6) receives the request and measures the reference measuring quantity in order to detect the second measurement value.

In another preferred embodiment, the measuring method as described herein, characterized in that the request contains a point in time at which the reference measuring quantity is to be measured, wherein the second measuring device (6) measures the reference measuring quantity at the point in time or as closely as possible to the point in time.

In another preferred embodiment, the measuring method as described herein, characterized in that the first measuring device (3) generates a first time stamp during the detection of the first measurement value, wherein the second measuring device (6) generates a second time stamp during the detection of the second measurement value, wherein a data transmission of the second time stamp from the second measuring device (6) to the first measuring device (3) takes place, and wherein the first measuring device (3) carries out the determination of the measurement result, using the first measurement value and the second measurement value, only if a difference in time between the first time stamp and the second time stamp does not exceed a maximum time interval.

In another preferred embodiment, the measuring method as described herein, characterized in that the second measuring device adds an identifier to the second measurement value, and that the first measuring device recognizes the second measurement value as an admissible measurement value based on the identifier.

In another preferred embodiment, a measuring assembly (1) for determining a measurement result, comprising:
a first measuring device (3) for measuring a measuring quantity at a measuring point, wherein the first measuring device (3) is configured for detecting a first measurement value during the measurement of the measuring quantity and for determining the measurement result using the first measurement value and a second measurement value, and
a second measuring device (6) for measuring a reference measuring quantity, wherein the second measuring device (6) is configured for detecting the second measurement value during the measurement of the reference measuring quantity and for causing a data transmission of the second measurement value from the second measuring device (6) to the first measuring device (3), so that the first measuring device (3) can determine the measurement result.

### BRIEF DESCRIPTION OF THE DRAWINGS

FIG. 1 is schematic representation of a first measuring assembly according to the invention for measuring a relative pressure.

FIG. 2 is a schematic representation of a second measuring assembly according to the invention for measuring a pressure differential.

FIG. 3 is a schematic representation of a third measuring assembly according to the invention for measuring a density.

FIG. 4 is a flow diagram showing method steps according to the invention.

### DETAILED DESCRIPTION OF THE INVENTION

According to a first aspect of the invention, a measuring method for determining a measurement result is specified, which comprises the following steps: measuring a measuring quantity by means of a first measuring device at a measuring point, wherein the first measuring device detects a first measurement value, measuring a reference measuring quantity by means of a second measuring device, wherein the second measuring device detects a second measurement value, data transmission of the second measurement value from the second measuring device to the first measuring device, and determination of the measurement result by the first measuring device using the first measurement value and the second measurement value. Consequently, a determination of the measurement result by a central unit is not necessary. Instead, the measurement result is determined by the first measuring device. The measuring devices may have sensors of any type. The measuring devices may further have communication means, e.g. network adapters for communication via wired and/or wireless networks. Thus, the data transmission between the first measuring device and the second measuring device may take place via a wired or a wireless network, or also via a direct connection. In principle, the measuring quantity and the reference measuring quantity may be any measuring quantities. The measuring quantity and the reference measuring quantity may have the same physical unit or different physical units. However, if quantities with the same physical unit are measured, it is critical that the measuring quantity and the reference measuring quantity constitute different special measuring quantities, i.e. relate to different situations to be subjected to a measurement (e.g. the measurement of the same physical quantity at different locations).

It is advantageous if the measuring quantity is an absolute pressure in a container, such as a tank, a pipe or the like, the reference measuring quantity is an atmospheric pressure, and the measurement result is a relative pressure. It is thus made possible to determine a relative pressure which is present in a container, for example. In order to determine a relative pressure, first, an absolute pressure may be measured in the container. This may be done by means of an absolute pressure sensor, which is part of the first measuring device. This is advantageous because the absolute pressure measurement is particularly accurate. The absolute pressure is the pressure relative to empty space/vacuum. After measuring the absolute pressure, the relative pressure may be determined taking into account the atmospheric pressure. Preferably, the first measuring device and the second measuring device each have at least one pressure sensor for measuring the absolute pressure or the relative pressure.

Preferably, the first measuring device calculates a difference between the first measurement value and the second measurement value for determining the measurement result. Preferably, this is done by the first measuring device subtracting the atmospheric pressure from the absolute pressure in order to determine the measurement result. The relative pressure can be obtained in the way. Since the atmospheric pressure may be subject to deviations of 30 mbars due to weather changes and deviations of up to 200 mbars due to positional changes, a standard value for the atmosphere pressure may not be used; rather, a continuous measurement is required.

Preferably, the first measuring device displays the relative pressure on a display means of the first measuring device. One advantage of the method according to the invention is the fact that the relative pressure is directly determined by the first measuring device. Thus, the relative pressure may also be displayed by the first measuring device. According to the invention, the display means may be an LCD display, a touchscreen or a display means of a different kind.

According to a special embodiment of the invention, the first measuring device derives a filling level in the container from the measurement result. A filling level in the container may be calculated based on the relative pressure. The measured hydrostatic pressure changes depending on an amount of a filling material present in the container, which may be a liquid, for example. Using a suitable conversion factor, the filling level may be determined therefrom. Accordingly, the first measuring device is also suitable as a filling level measuring device.

According to the invention, it is possible that the measuring quantity is a first pressure in a container, such as a tank, a pipe or the like, that the reference measuring quantity is a second pressure, and that the measurement result is a pressure differential. Consequently, it is also possible to determine a pressure differential using the method according to the invention. For this purpose, the first measuring device and the second measuring device preferably each have a pressure sensor. The second pressure is preferably measured inside the container, but may also be measured outside the container. It should be understood that the pressure differential is to be determined by calculating a difference between the first measurement value and the second measurement value. It is advantageous if the first measuring device and the second measuring device have the same design. Also, no other distinction has to be made between the first measuring device and the second measuring device, e.g. a classification of the first measuring device as a master and of the second measuring device as a slave in the measuring process and the communication, as it is common in measuring assemblies for determining the pressure differential according to the prior art.

According to an advantageous embodiment of the invention, the measuring quantity and the reference measuring quantity are different physical quantities. In that case, special measurement results may be determined based on the first measurement value and the second measurement value. For example, it may be provided, according to the invention, that the measuring quantity is a hydrostatic pressure in a container, such as a tank, a pipe or the like, that the reference measuring quantity is a distance between the second measuring device and a filling level of a filling material in the container, and that the measurement result is a density of the filling material, wherein the first measuring device has a pressure sensor and the second measuring device has a distance sensor. The density of the filling material may be calculated based on the filling level and the hydrostatic pressure present in the container, possibly using other auxiliary quantities. According to the invention, it is possible that the distance sensor is a radar sensor; however, it may also be a distance sensor of another type.

According to the invention, it is possible that the second measuring device is disposed remote from the measuring point. This means that the second measuring device is not disposed in or on the measuring point. If the measuring point is formed by a container, for instance, then the second measuring device is not disposed in or on the container. In the embodiment of the invention in which a relative pressure is determined, the atmospheric pressure is not required to be measured at the measuring point. An air pressure measured inside a ventilated container most frequently differs only to a small extent from an atmospheric pressure measured outside the container. Therefore, it may be expedient to measure the atmospheric pressure elsewhere. According to the invention, it is also conceivable that several first measuring devices jointly use a single second measuring device. Thus, the reference measuring quantity only has to be determined by a single measuring device.

According to the invention, the method may be designed such that, in the process, at least one additional measuring device measures the reference measuring quantity, wherein the at least one additional measuring device detects an additional measurement value, wherein a data transmission of the additional measurement value from the additional measuring device to the first measuring device takes place, and wherein the first measuring device compares the second measurement value with the additional measurement value prior to the determination of the measurement result in order to discard and/or correct the second measurement value. Thus, the reference measuring quantity is measured by different devices. Measurement errors can be corrected. Moreover, another option for obtaining the reference measuring quantity by means of the first measuring device is provided for the case of a failure of the second measuring device. If the first measuring device discards the second measurement value, then, according to the invention, it can use the additional measurement value for the determination of the measurement result instead, or it can wait for the receipt of another measurement value from the second measuring device.

If several additional measuring devices are provided, then the first measuring device receives several additional measurement values. According to the invention, the method may be designed such that the first measuring device carries out a voting process. Thus, the method exploits redundancies. According to the invention, it may thus carry out a voting process in accordance with the 1002 principle, in accordance with the 2002 principle, in accordance with the 2003 principle or in accordance with related voting processes. It is particularly advantageous if the first measuring device selects a suitable voting process depending on the number of additional measuring devices present, or on the number of additional measurement values provided by them. According to one example, voting in accordance with the 2002 principle could be carried out if only one additional measuring device is present, and when another additional measuring device is added, the first measuring device could automatically switch over to voting in accordance with the 2003 principle. In addition to the known voting processes, a person skilled in the art may also use other error correction methods that are conceivable when obtaining measurement values from different measuring points, e.g. calculating an average value from the obtained measurement values.

According to another variant of a method according to the invention, one additional measuring device measures the reference measuring quantity, wherein the at least one additional measuring device detects an additional measurement value, wherein a data transmission of the additional measurement value from the additional measuring device to the second measuring device takes place, and wherein the second measuring device compares the second measurement value with the additional measurement value and outputs an error signal if a difference between the second measurement value and the additional measurement value exceeds a threshold value. In this way, the second measuring device can verify whether its measurements are still correct. If the values measured by the second measuring device and the additional measuring device deviate too much from each other, then it is possible that at least one of the two measuring devices is malfunctioning or needs to be recalibrated. According to the above-described variant of the method, a plurality of measuring devices may provide to one another measurement values relating to the reference measuring quantity and thus verify whether they still function correctly.

Preferably the first measuring device, in addition to the measuring quantity, measures the reference measuring quantity, wherein the first measuring device detects a third measurement value, and wherein a data transmission of the third measurement value from the first measuring device to at least one third measuring device takes place. It is possible that the first measuring device also measures the reference measuring quantity if the first measuring device has a sensor suitable for this purpose. If the first measuring device measures an absolute pressure as the measuring quantity and an atmospheric pressure as the reference measuring quantity, for example, then it can transmit to other measuring devices a third measurement value representing the atmospheric pressure. In a system of several measuring devices, a separate measuring device configured exclusively for measuring the atmospheric pressure is thus not necessary—the required measurement values are detected by the first measuring device.

It is advantageous if the first measuring device sends a request, whereupon the second measuring device receives the request and measures the reference measuring quantity in order to detect the second measurement value. According to the invention, the request may be received via a network, for example, or also via any other data connection which, according to the invention, may also be configured to be wireless. Thus, the measurement of the reference measuring quantity is replaced by a query in the context of a polling process. However, embodiments of the method according to the invention are also possible in which the second measuring device itself triggers the measurement of the reference measuring quantity. For example, the reference measuring quantity may be measured by the second measuring device at a regular time interval.

Preferably, the request contains a point in time at which the reference measuring quantity is to be measured, wherein the second measuring device measures the reference measuring quantity at the point in time or as closely as possible to the point in time. For this purpose, the second measuring device may be equipped with a clock that the second measuring device can preferably synchronize with an external time source, e.g. via a network connection. The measurement of the reference measuring quantity at a specific point in time is important particularly if a pressure differential is to be measured. Thus, the first measuring device can specify when the second measuring device is supposed to measure the reference measuring quantity. The first measuring device preferably measures the measuring quantity also at this point in time. The measuring quantity may be a first pressure, and the reference measuring quantity may be a second pressure, from which a pressure differential is subsequently calculated.

Preferably, the first measuring device generates a first time stamp during the detection of the first measurement value, wherein the second measuring device generates a second time stamp during the detection of the second measurement value, wherein a data transmission of the second time stamp from the second measuring device to the first measuring device takes place, and wherein the first measuring device carries out the determination of the measurement result, using the first measurement value and the second measurement value, only if a difference in time between the first time stamp and the second time stamp does not exceed a maximum time interval. The first measuring device can thus measure the measurement value and wait for the receipt of an admissible measurement value that is suitable for determining the measurement result. Also in this case, it is conceivable, as a possible case of application, that a pressure differential is to be determined, wherein an underlying first pressure and an underlying second pressure are supposed to not be too far apart in time. It is not absolutely necessary for the first measuring device to actively poll the reference measuring quantity from the second measuring device as described above; rather, the receipt of an admissible second measurement value from the second measuring device may simply be awaited.

It is advantageous if the method according to the invention is designed such that the second measuring device adds an identifier to the second measurement value, and that the first measuring device recognizes the second measurement value as an admissible measurement value based on the identifier. Thus, any second measuring devices may be added to a measuring assembly. If the first measuring device receives a second measurement value and recognizes its identifier, it can directly process the second measurement value in accordance with the method. Consequently, a laborious reconfiguration of the system when adding a new measuring device is not necessary.

According to another aspect of the invention, a measuring assembly for determining a measurement result is proposed, which comprises: a first measuring device for measuring a measuring quantity at a measuring point, wherein the first measuring device is configured for detecting a first measurement value during the measurement of the measuring quantity and for determining the measurement result using the first measurement value and a second measurement value, and a second measuring device for measuring a reference measuring quantity, wherein the second measuring device is configured for detecting the second measurement value during the measurement of the reference measuring quantity and for causing a data transmission of the second measurement value from the second measuring device to the first measuring device, so that the first measuring device can determine the measurement result. Preferably, this measuring assembly is configured such that it can carry out the above-described method also in accordance with its different optional variants. When the second measuring device causes the data transmission of the second measurement value to the first measuring device, then this is not necessarily to be understood to be a directed data transmission in which only the first measuring device is the addressee. For example, the second measurement value may also be transmitted in a broadcast packet.

In particular, it is possible, according to the invention, that the first measuring device is configured for measuring an absolute pressure, that the second measuring device is configured for measuring an atmospheric pressure, and that the first measuring device is configured for determining a relative pressure on the basis of the first pressure and the second pressure in order to provide the measurement result. It should be understood that the first measuring device and the second measuring device have pressure sensors in this case. Preferably, the first measuring device is arranged in a container. In it, it can measure the absolute pressure. For measuring the absolute pressure, the first measuring device preferably has an absolute pressure sensor. The second measuring device is preferably arranged in such a way that it can measure the atmospheric pressure. For this purpose, the second measuring device is preferably disposed outside the container. It is particularly preferable if the first measuring device is configured for determining the measurement result by calculating a difference between the first measurement value and the second measurement value. According to an advantageous embodiment of the invention, the measuring device has a display means and is configured for displaying the relative pressure on the display means. According to the invention, the first measuring device may further be configured such that it can derive from the measurement result a filling level in a container, such as a tank, a pipe or the like.

According to an alternative embodiment of the measuring assembly, it is possible that the measuring quantity is a first pressure in a container, such as a tank, a pipe or the like, that the reference measuring quantity is a second pressure in the container, and that the measurement result is a pressure differential. In this case, the first measuring device and the second measuring device preferably have pressure sensors. According to another variant of the measuring assembly, it may be provided that the measuring quantity and the reference measuring quantity are different physical quantities. In this case, it is advantageous if the measuring quantity is a hydrostatic pressure in a container, such as a tank, a pipe or the like, that the reference measuring quantity is a distance between the second measuring device and a filling level of a filling material in the container, and that the measurement result is a density of the filling material. In this embodiment of the invention, the first measuring device has a pressure sensor and the second measuring device has a distance sensor.

The measuring assembly preferably has at least one additional measuring device, wherein the at least one additional measuring device is configured for measuring the reference measuring quantity and detect an additional measurement value in the process, wherein the at least one additional measuring device is configured for transmitting the additional measurement value, wherein the first measuring device is configured for receiving the additional measurement value, and wherein the first measuring device is configured for comparing the second measurement value with the additional measurement value prior to the determination of the measurement result in order to discard and/or correct the second measurement value. According to the invention, it is possible, moreover, that the additional measuring device is configured for measuring the reference measuring quantity, detect at least one additional measurement value and transmit the additional measurement value, wherein the second measuring device is configured for receiving the additional measurement value, and wherein the second measuring device is configured for comparing the second measurement value with the additional measurement value and output an error signal if a difference between the second measurement value and the additional measurement value exceeds a threshold value.

According to an advantageous variant of the measuring assembly according to the invention, the first measuring device is configured to measure, in addition to the measuring quantity, the reference measuring quantity, and to detect a third measurement value in the process, wherein the first measuring device is configured for transmitting the third measurement value, and wherein the measuring assembly further has at least one third measuring device configured for receiving the third measurement value. In this variant of the measuring assembly, the first measuring device must have a sensor for measuring the reference measuring quantity.

Preferably, the first measuring device is configured for sending a request, and the second measuring device is configured for receiving the request and to measure the reference measuring quantity thereupon, in order to determine the second measurement value. According to the invention, it is possible that the request contains a point in time at which the reference measuring quantity is to be measured, wherein the second measuring device is configured for measuring the reference measuring quantity at the point in time or as closely as possible to the point in time.

Preferably, the first measuring device is configured for generating a first time stamp during the detection of the first measurement value, the second measuring device is configured for generating a second time stamp during the detection of the second measurement value, the second measuring device is configured for sending the second time stamp, the first measuring device is configured for receiving the second time stamp, and the first measuring device is configured for carrying out the determination of the measurement result, using the first measurement value and the second measurement value, only if a difference in time between the first time stamp and the second time stamp does not exceed a maximum time interval. Particularly preferably, the second measuring device is configured for adding an identifier to the second measurement value, and the first measuring device is configured for recognizing the second measurement value as an admissible measurement value based on the identifier.

It should be understood that the measuring assembly may include other devices that are useful for carrying out the above-described method. According to the invention, the measuring assembly may include communication lines, for instance. They may connect the measuring devices to each other directly or indirectly. The measuring assembly may also have a control unit. The latter may retrieve data from the measuring devices and transmit them to them, as well as serve as a communication node connected between the measuring devices.

### DETAILED DESCRIPTION OF THE FIGURES

FIG. 1 shows a schematic representation of a first measuring assembly 1 according to the invention for measuring a relative pressure. Several containers 2 are depicted. A first measuring device 3 is disposed in each container 2. The first measuring device 3 has a sensor for measuring an absolute pressure. Each of the first measuring devices 3 is connected to a control unit 5 via a communication line 4. A second measuring device 6 is connected to the control unit 5 via another communication line 4. The second measuring device 6 also has a sensor for measuring an absolute pressure. According to the depicted measuring assembly 1, the second measuring device 6 is disposed outdoors, so that it can measure an atmospheric pressure. The first measuring device 3 measures an absolute pressure of a liquid in the container 2, wherein it detects a first measurement value. The second measuring device 6 measures the atmospheric pressure and in the process detects a second measurement value. The second measuring device 6 transmits the second measurement value via the control unit 5 and the communication lines 4 to the first measuring device 3. The first measuring device 3 subtracts the second measurement value from the first measurement value and thus obtains a relative pressure of the liquid in the container 2. From the relative pressure, the first measuring device derives a filling level of the liquid in the container.

The measuring assembly further has two additional measuring devices 7. The additional measuring devices 7 have sensors for measuring an absolute pressure and, like the second measuring device 6, are arranged such that they can measure an atmospheric pressure. The additional measuring devices 7 each detect an additional measurement value. The two additional measurement values are transmitted via the communication lines 4 and the control unit 5 to the first measuring device 3. The first measuring device 3 uses the additional measurement values to verify whether the second measurement value, which the first measuring device 3 has obtained from the second measuring device 6, is correct. For this purpose, the first measuring device 3 carries out a 2003 voting process. For this purpose, it takes into account the second measurement value and the two additional measurement values. Thus, the second measurement value may be discarded, for instance, if it deviates too much from the two additional measurement values. According to another operating mode of the first measuring device 3, the first measuring device 3 calculates an average from the second measurement value and the two additional measurement values and corrects the second measurement value in this manner. The additional measuring devices 7 transmit the additional measurement values also to the second measuring device 6. Moreover, the second measuring device 6 transmits the second measurement value, which it has detected, to the additional measuring devices 7. The measuring devices verify obtained measurement values with measurement values they detected themselves. In this manner, the second measuring device 6 and the additional measuring devices 7 can verify whether they are still detecting admissible measurement values. If the measurement values differ too much, then this may indicate a malfunction.

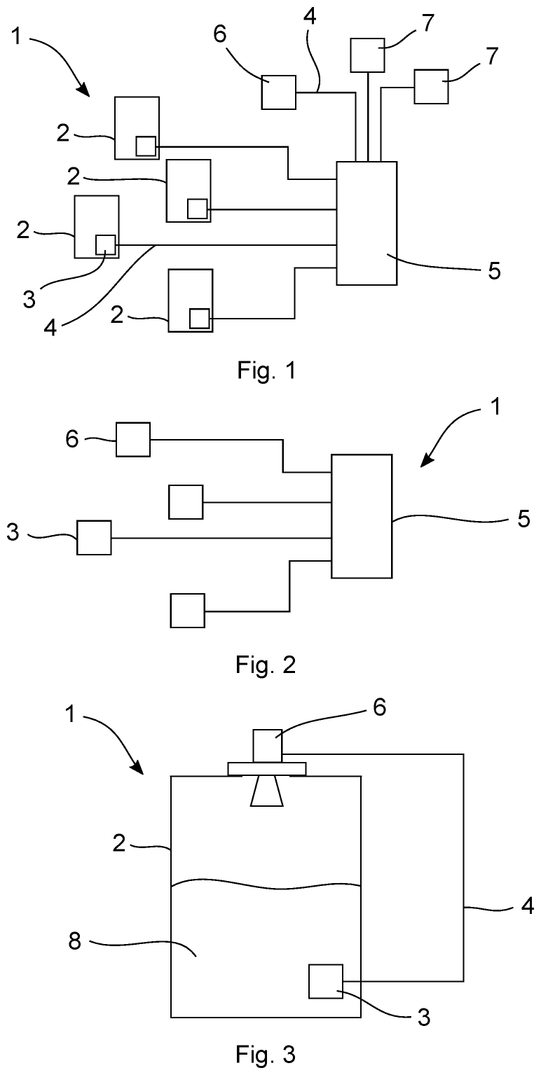

FIG. 2 shows a schematic representation of a second measuring assembly 1 according to the invention for measuring a pressure differential. The measuring assembly 1 has several measuring devices with a design of the same kind. One of the measuring devices is a first measuring device 3 that is to determine a pressure differential. It sends a request via a network, which is formed by a control unit 5 and a plurality of measuring devices connected therewith, to a second measuring device. A point in time at which the second measuring device is supposed to measure a pressure is indicated in the request. At the point in time, the first measuring device 3 measures an absolute pressure, wherein it detects a first measurement value.

At the point in time, the second measuring device 6 also measures an absolute pressure, wherein it detects a second measurement value. The second measuring device 6 transmits the second measurement value to the first measuring device 3 via the network. The first measuring device 3 calculates a difference between the first measuring device and the second measuring device and in this manner determines the pressure differential.

FIG. 3 shows a schematic representation of a third measuring assembly 1 according to the invention for measuring a density. A liquid 8, whose density is to be determined, is located in a container 2. A first measuring device 3 having a pressure sensor is disposed in the container. The measuring device 3 is connected to a second measuring device 6 via a communication line 4. The first measuring device 3 measures a pressure of the liquid 8, wherein it determines a first measurement value. The second measuring device 6 is a radar distance sensor. It measures a distance between the second measuring device 6 and a surface of the liquid 8, wherein it determines a second measurement value. The second measuring device 6 transmits the second measurement value to the first measuring device 3 via the communication line 4. Based on the first measurement value and the second measurement value, the first measuring device 3 subsequently determines a density of the liquid 8.

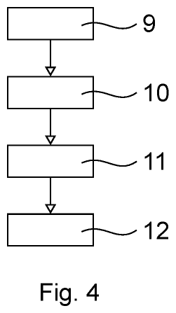

FIG. 4 shows a flow diagram showing method steps according to the invention. In a first measuring step 9, a first measuring device measures a measuring quantity. For example, this may be an absolute pressure measured in a container, but also another arbitrary measuring quantity. A first measurement value results in the measurement of the measuring quantity. In a second measuring step 10, a second measuring device measures a reference measuring quantity. For example, this may be an atmospheric pressure, but also another arbitrary reference measuring quantity. A second measurement value results in the measurement of the reference measuring quantity. It should be noted that it is not absolutely required that the first measuring step 9 and the second measuring step 10 be carried out in the depicted order, but that they can also be reversed in order, or the two steps can also be carried out simultaneously.

In a transmission step 11, a data transmission of the second measurement value takes place from the second measuring device to the first measuring device. This may take place, for example, via a wired network or a wireless data connection. It must be noted that the transmission step 11 does not absolutely have to be carried out after the first measuring step 9, because it is also possible that the first measuring device determines the first measurement value only after it has obtained the second measurement value. After determining the first measurement value and obtaining the second measurement value, the first measuring device determines a measurement result from the first measurement value and the second measurement value in a determination step 12. For example, the measurement result may be a relative pressure, a pressure differential or a density of a liquid, corresponding to the embodiments of the invention introduced in FIGS. 1 to 3. However, the determination of other measurement results is also conceivable.

### LIST OF REFERENCE NUMBERS

1 Measuring assembly
2 Container
3 First measuring device
4 Communication line
5 Control unit
6 Second measuring device
7 Additional measuring device
8 Liquid
9 First measuring step
10 Second measuring step
11 Transmission step
12 Determination step

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

It must be noted that the features cited individually in the claims can be combined with each other in any technologically meaningful manner (also across the boundaries of categories, such as method and device) and represent other embodiments of the invention. The description, in particular in connection with the figures, additionally characterizes and specifies the invention.

It may also be noted that a conjunction “and/or” used hereinafter, which is situated between two features and links them to each other, should always be interpreted such that, in a first embodiment of the subject matter according to the invention, only the first feature may be provided, in a second embodiment, only the second feature may be provided, and in a third embodiment, both the first and the second feature may be provided.

1. A measuring method for determining a measurement result, comprising the steps of:
measuring a measuring quantity by means of a first measuring device at a measuring point, wherein the first measuring device detects a first measurement value,
measuring a reference measuring quantity by means of a second measuring device, wherein the second measuring device detects a second measurement value,
data transmission of the second measurement value from the second measuring device to the first measuring device, and
determination of the measurement result by the first measuring device using the first measurement value and the second measurement value.

2. The measuring method according to claim 1, wherein the measuring quantity is an absolute pressure in a container, the reference measuring quantity is an atmospheric pressure, and the measurement result is a relative pressure.

3. The measuring method according to claim 1, wherein the first measuring device calculates a difference between the first measurement value and the second measurement value for determining the measurement result.

4. The measuring method according to claim 2, wherein the first measuring device displays the relative pressure on a display means of the first measuring device.

5. The measuring method according to claim 2, wherein the first measuring device derives a filling level in the container from the measurement result.

6. The measuring method according to claim 1, wherein the measuring quantity is a first pressure in a container, such as a tank, a pipe or the like, that the reference measuring quantity is a second pressure, and that the measurement result is a pressure differential.

7. The measuring method according to claim 1, wherein the measuring quantity and the reference measuring quantity are different physical quantities.

8. The measuring method according to claim 7, wherein the measuring quantity is a pressure in a container, such as a tank, a pipe or the like, that the reference measuring quantity is a distance between the second measuring device and a filling level of a filling material in the container, and that the measurement result is a density of the filling material, wherein the first measuring device has a pressure sensor and the second measuring device has a distance sensor.

9. The measuring method according to claim 1, wherein the second measuring device is disposed remote from the measuring point.

10. The measuring method according to claim 1, wherein at least one additional measuring device measures the reference measuring quantity, wherein the at least one additional measuring device detects an additional measurement value, wherein a data transmission of the additional measurement value from the additional measuring device to the first measuring device takes place, and wherein the first measuring device compares the second measurement value with the additional measurement value prior to the determination of the measurement result in order to discard and/or correct the second measurement value.

11. The measuring method according to claim 1, wherein at least one additional measuring device measures the reference measuring quantity, wherein the at least one additional measuring device detects an additional measurement value, wherein a data transmission of the additional measurement value from the additional measuring device to the second measuring device takes place, and wherein the second measuring device compares the second measurement value with the additional measurement value and outputs an error signal if a difference between the second measurement value and the additional measurement value exceeds a threshold value.

12. The measuring method according to claim 1, wherein the first measuring device, in addition to the measuring quantity, measures the reference measuring quantity, wherein the first measuring device detects a third measurement value, and wherein a data transmission of the third measurement value from the first measuring device to at least one third measuring device takes place.

13. The measuring method according to claim 1, wherein the first measuring device sends a request, whereupon the second measuring device receives the request and measures the reference measuring quantity in order to detect the second measurement value.

14. The measuring method according to claim 13, wherein the request contains a point in time at which the reference measuring quantity is to be measured, wherein the second measuring device measures the reference measuring quantity at the point in time or as closely as possible to the point in time.

15. The measuring method according to claim 1, wherein the first measuring device generates a first time stamp during the detection of the first measurement value, wherein the second measuring device generates a second time stamp during the detection of the second measurement value, wherein a data transmission of the second time stamp from the second measuring device to the first measuring device takes place, and wherein the first measuring device carries out the determination of the measurement result, using the first measurement value and the second measurement value, only if a difference in time between the first time stamp and the second time stamp does not exceed a maximum time interval.

16. The measuring method according to claim 1, wherein the second measuring device adds an identifier to the second measurement value, and that the first measuring device recognizes the second measurement value as an admissible measurement value based on the identifier.

17. A measuring assembly for determining a measurement result, comprising:
a first measuring device for measuring a measuring quantity at a measuring point, wherein the first measuring device is configured for detecting a first measurement value during the measurement of the measuring quantity and for determining the measurement result using the first measurement value and a second measurement value, and
a second measuring device for measuring a reference measuring quantity, wherein the second measuring device is configured for detecting the second measurement value during the measurement of the reference measuring quantity and for causing a data transmission of the second measurement value from the second measuring device to the first measuring device, so that the first measuring device can determine the measurement result.
